(19) United States
(12) Patent Application Publication
(10) Pub. No.: US 2022/0038390 A1
(43) Pub. Date: Feb. 3, 2022

(54) DESIGN MANAGEMENT APPARATUS, CONTROL METHOD THEREOF, PROGRAM AND MANAGEMENT SYSTEM

(71) Applicant: NEC Corporation, Minato-ku, Tokyo (JP)

(72) Inventor: Masahiko TAKANOHASHI, Tokyo (JP)

(73) Assignee: NEC Corporation, Minato-ku, Tokyo (JP)

(21) Appl. No.: 17/276,993

(22) PCT Filed: Sep. 24, 2019
(86) PCT No.: PCT/JP2019/037168

§ 371 Date: Mar. 17, 2021

(30) Foreign Application Priority Data
Sep. 25, 2018 (JP) 2018-178348

(51) Int. Cl. H04L 12/911; H04L 12/24; H04L 29/08; H04L 12/927

(52) U.S. Cl. CPC H04L 47/823; H04L 47/803; H04L 67/125; H04L 41/145

(57) ABSTRACT

A design management apparatus includes: a system requirement obtaining part which obtains a system requirement of a managed system configured to include a managed apparatus(es); a requested resource determination part which determines a requested resource(s) based on the system requirement; a spare resource determination part which determines a spare resource(s) by performing a fluctuation prediction on the system requirement; and a system configuration determination part which determines system configuration information regarding a system configuration including the requested resource(s) and the spare resource(s).

### FIELD

### Reference to Related Application

The present invention is based upon and claims the benefit of the priority of Japanese patent application No. 2018-178348, filed on Sep. 25, 2018, the disclosure of which is incorporated herein in its entirety by reference thereto.

The present invention relates to a design management apparatus, a supply management apparatus, a system operations management apparatus, a management system, a control method and a program.

### BACKGROUND

In recent years, it becomes possible to utilize IT (Information Technology) close at hand in daily life by using IoT (Internet of Things). IoT is a mutually controlling scheme between “things” and servers by connecting “things” such as sensors and devices to clouds or servers through an internet.

When a system using apparatuses to realize IoT (hereinafter called an IoT device) is constructed, an administrator side of the system procures IoT devices and an application. Then, the administrator side of the system sets up the IoT devices after the IoT devices are delivered in such manner that functions provided by the application can be performed by the IoT devices. Then, the administrator side of the system performs operation tests of the IoT devices after the IoT devices are deployed. When an administrator of the system constructs a system using such IoT devices, it is preferable to be able to efficiently procure the IoT devices and efficiently construct the system.

Patent Literature (PTL) 1 discloses, with respect to instances (virtual machines) provided by a cloud provider, a technology to search for a time period during which the instances will be relatively inexpensive based on prediction results of future instance price trend.

### CITATION LIST

### Patent Literature

PTL 1: WO2017/022826A1

### SUMMARY

### Technical Problem

The disclosure of the above Patent Literature is incorporated herein by reference thereto. The following analysis has been given from a view of the present invention.

When a failure (physical breakage, overload and so on) occurs in a system utilizing IoT devices, there is a case where a system will be stopped, usage restriction and so on will be performed, a system will be redesigned, an additional order of IoT devices will be placed, system construction and testing will be performed. In that case, it takes a lot of time to recover a system, which offers great impact on users.

However, an operation mode of a system utilizing IoT devices differs according to user activities and usage scenes. Therefore, when operating a system utilizing IoT devices, it is difficult to predict possible failures (physical breakage, overload and so on) in advance.

In a technology described in PTL 1, it is not described at all that it becomes necessary to redesign a system when a failure occurs and so on.

Accordingly, it is an object of the present invention to provide a design management apparatus, a supply management apparatus, a system operations management apparatus, a management system, a control method and a program which contribute to promptly implement a design change in a system and operate the system.

### Solution to Problem

According to a first aspect, there is provided a design management apparatus. The design management apparatus includes a system requirement obtaining part which obtains a system requirement of a managed system configured to include a managed apparatus(es). Furthermore, the design management apparatus includes a requested resource determination part which determines a requested resource(s) based on the system requirement.

Furthermore, the design management apparatus includes a spare resource determination part which determines a spare resource(s) by performing a fluctuation prediction on the system requirement.

Furthermore, the design management apparatus includes a system configuration determination part which determines a system configuration including the requested resource(s) and the spare resource(s).

According to a second aspect, there is provided a management system. The management system is configured to include a design management apparatus and a supply management apparatus.

The design management apparatus includes a system requirement obtaining part which obtains a system requirement of a managed system configured to include a managed apparatus(es).

Furthermore, the design management apparatus includes a requested resource determination part which determines a requested resource(s) based on the system requirement.

Furthermore, the design management apparatus includes a spare resource determination part which determines a spare resource(s) by performing a fluctuation prediction on the system requirement.

Furthermore, the design management apparatus includes a system configuration determination part which determines a system configuration including the requested resource(s) and the spare resource(s), and transmits the system configuration information to the supply management apparatus.

The supply management apparatus secures an apparatus(es) corresponding to the requested resource(s) and the spare resource(s) as a managed apparatus(es) if the system configuration information is received, and performs a processing of delivering a managed apparatus(es) corresponding to the requested resource(s) to an end user of the managed system.

According to a third aspect, there is provided a control method of a design management apparatus. The present control method includes a step of obtaining a system requirement of a managed system configured to include a managed apparatus(es).

Furthermore, the present control method includes a step of determining a requested resource(s) based on the system requirement.

Furthermore, the present control method includes a step of determining a spare resource(s) by performing a fluctuation prediction on the system requirement.

Furthermore, the present control method includes a step of determining system configuration information regarding a system configuration including the requested resource(s) and the spare resource(s).

Note, the present method is tied to a particular machine, namely, a design management apparatus.

According to a fourth aspect, there is provided a control method of a supply management apparatus. The present control method includes a step of receiving a system configuration information regarding a system configuration including a requested resource(s) and a spare resource(s) which is information regarding a managed system configured to include a managed apparatus(es).

Furthermore, the present control method includes a step of securing an apparatus(es) corresponding to the requested resource(s) and the spare resource(s) as a managed apparatus(es) if the system configuration information is received.

Furthermore, the present control method includes a step of performing a processing of delivering a managed apparatus(es) corresponding to the requested resource(s) to an end user of the managed system.

Note, the present method is tied to a particular machine, namely, a supply management apparatus.

According to a fifth aspect, there is provided a control method of system operations management apparatus. The present control method includes a step of receiving information on an operation state(s) of a managed apparatus(es).

Furthermore, the present control method includes a step of determining whether or not it is necessary to add a managed apparatus(es) to the managed system based on the information regarding the operation state(s).

Note, the present method is tied to a particular machine, namely, a system operations management apparatus.

According to a sixth aspect, there is provided a program that causes a computer which controls a design management apparatus to execute. The present program causes a computer which controls a design management apparatus to execute a processing of obtaining a system requirement of a managed system configured to include a managed apparatus(es).

Furthermore, the present program causes a computer which controls a design management apparatus to execute a processing of determining a requested resource(s) based on the system requirement.

Furthermore, the present program causes a computer which controls a design management apparatus to execute a processing of determining a spare resource(s) by performing a fluctuation prediction on the system requirement.

Furthermore, the present program causes a computer which controls a design management apparatus to execute a processing of determining system configuration information regarding a system configuration including the requested resource(s) and the spare resource(s).

According to a seventh aspect, there is provided a program that causes a computer which controls a supply management apparatus to execute. The present program causes a computer which controls a supply management apparatus to execute a processing of receiving a system configuration information regarding a system configuration including a requested resource(s) and a spare resource(s) which is information regarding a managed system configured to include a managed apparatus(es).

Furthermore, the present program causes a computer which controls a supply management apparatus to execute a processing of securing an apparatus(es) corresponding to the requested resource(s) and the spare resource(s) as a managed apparatus(es) if the system configuration information is received.

Furthermore, the present program causes a computer which controls a supply management apparatus to execute a processing of performing a processing of delivering a managed apparatus(es) corresponding to the requested resource(s) to an end user of the managed system.

According to an eighth aspect, there is provided a program that causes a computer which controls a system operations management apparatus to execute. The present program causes a computer which controls a system operations management apparatus to execute a processing of receiving information on an operation state(s) of a managed apparatus(es).

Furthermore, the present program causes a computer which controls a system operations management apparatus to execute a processing of determining whether or not it is necessary to add a managed apparatus(es) to the managed system based on the information regarding the operation state(s).

It is to be noted that these programs can be recorded on a computer-readable storage medium. The storage medium can be non-transient one, such as a semiconductor memory, a hard disk, a magnetic recording media, an optical recording media and so on. The present invention can be implemented as a computer program product.

### Advantageous Effects of Invention

According to the present invention, there are provided a design management apparatus, a supply management apparatus, a system operations management apparatus, a management system, a control method and a program which contribute to promptly implement a design change in a system and operate the system.

### BRIEF DESCRIPTION OF DRAWINGS

FIG. 1 illustrates an outline of an example embodiment.

FIG. 2 shows a block diagram illustrates a whole configuration of a management system according to a present example embodiment.

FIG. 3 shows a block diagram illustrating an internal configuration of a design management control part 103.

FIG. 4 shows a flow chart illustrating an example of an operation of a management system.

FIG. 5 shows a flow chart illustrating an example of an operation of a management system.

FIG. 6 shows a flow chart illustrating an example of an operation of a management system.

FIG. 7 shows a block diagram illustrating an example of a hardware configuration of a computer 10.

### DESCRIPTION OF EXAMPLE EMBODIMENTS

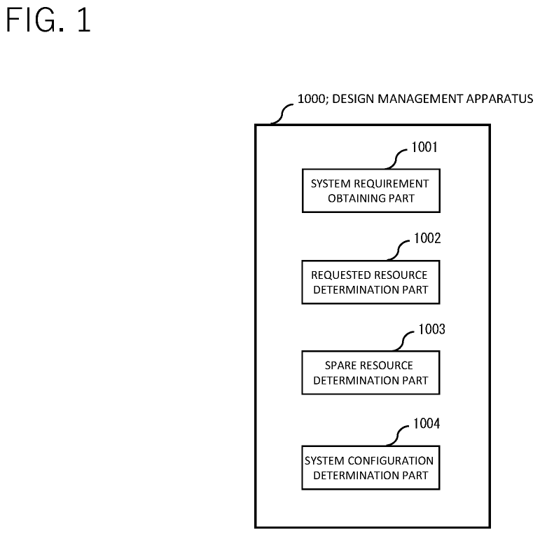

First, an outline of an example embodiment will be described with reference to FIG. 1. Note, in the following outline, reference signs of the drawings are denoted to each element as an example for the sake of convenience to facilitate understanding and description of this outline is not intended to any limitation. An individual connection line between blocks in an individual block diagram includes both one-way and two-way directions. A one-way arrow schematically illustrates a principal signal (data) flow and does not exclude bidirectionality. Furthermore, while not illustrated, an input port(s) and an output port(s) exist respectively at an input terminal(s) and an output terminal(s) of respective connection lines in circuit diagrams, block diagrams, internal configuration diagrams, connection diagrams and so on shown in the present disclosure. The same applies to an input/output interface(s).

As described above, a design management apparatus which contributes to promptly implement a design change in a system and operate the system is desired.

Accordingly, as an example, there is provided a design management apparatus 1000 as shown in FIG. 1. The design management apparatus 1000 incudes a system requirement obtaining part 1001, a requested resource determination part 1002, a spare resource determination part 1003 and a system configuration determination part 1004.

The system requirement obtaining part 1001 obtains a system requirement of a managed system configured to include a managed apparatus(es). The managed system is assumed to be configured to include one or more managed apparatuses. Furthermore, the managed apparatus may be, for example, an IoT device.

The requested resource determination part 1002 determines a requested resource(s) based on the system requirement obtained by the system requirement obtaining part 1001. The requested resource is a managed apparatus which satisfies a system requirement of a managed system.

The spare resource determination part 1003 determines a spare resource(s) by performing a fluctuation prediction on the system requirement. Here, the fluctuation prediction is to predict the number of a managed apparatus(es) and a setting(s) of the managed apparatus(es) which may be necessary if a system failure, overload and so on occur in the managed system. Furthermore, the spare resource is a managed apparatus which may become necessary if a system failure, overload and so on occur in the managed system.

The system configuration determination part 1004 determines system configuration information regarding a system configuration including the requested resource(s) and the spare resource(s).

That is, the design management apparatus 1000 determines a configuration of a managed system by predicting in advance the number of a managed apparatus(es) and a setting(s) of the managed apparatus(es) which may become necessary if a system failure, overload and so on occur. Therefore, the design management apparatus 1000 contributes to secure and set resources by assuming in advance that a system failure, overload and so on will occur. Therefore, the design management apparatus 1000 contributes to promptly implement a design change in a system and operates the system even when a design change of a system becomes necessary.

[First Example Embodiment]

A first example embodiment will be described in detail with reference to drawings.

In the following description, a managed apparatus is an apparatus which is a target to be managed and includes communication facilities. In the following description, it is assumed that a managed apparatus is an IoT device. Furthermore, in the following description, it is assumed that a managed system is a system which is configured to include a managed apparatus(es). Furthermore, in the following description, a managed apparatus included in a managed system is called a resource.

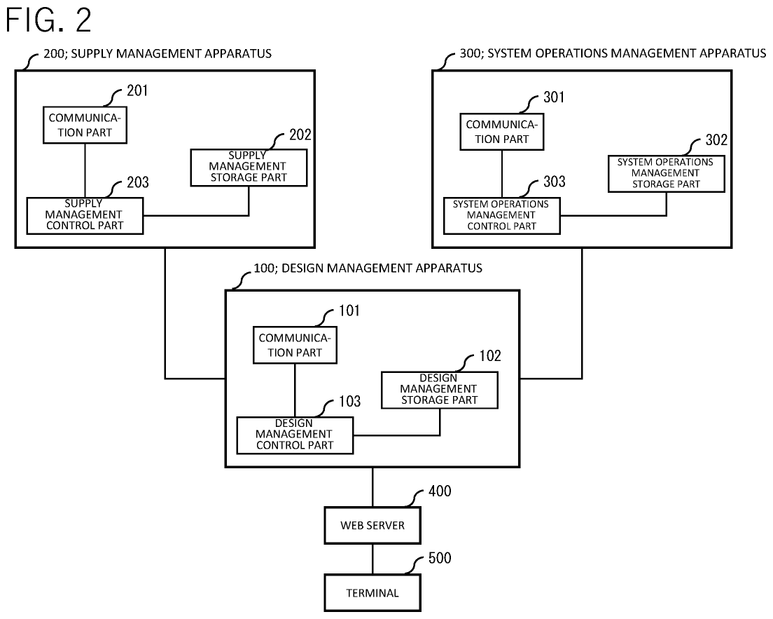

FIG. 2 illustrates an example of a whole configuration of a management system according to a present example embodiment. The management system according to the present example embodiment is configured to include a design management apparatus 100, a supply management apparatus 200 and a system operations management apparatus 300.

A terminal 500 is an information processing apparatus (computer) which a user uses. It is assumed that the terminal 500 includes communication facilities and can connect to a Web server 400 through a network. The terminal 500 may be a PC (Personal Computer), a smart phone and so on, and details thereof are not significant as long as it is an apparatus provided with communication facilities.

The Web serve 400 may function as a cloud broker (Cloud Broker) which mediates a cloud service. The cloud broker makes a service and application available for purchase and provides a user with a purchased service and application, through an internet.

The design management apparatus 100 is an information processing apparatus (computer) which determines resources so as to satisfy a system requirement of a managed system.

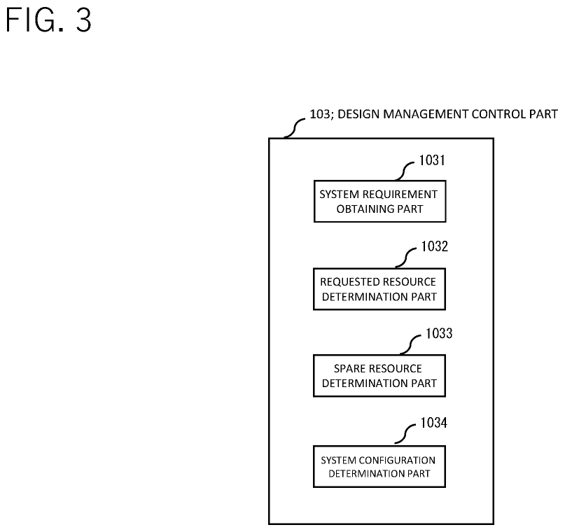

The design management apparatus 100 is configured to include a communication part 101, a design management storage part 102 and a design management control part 103. Furthermore, FIG. 3 shows a block diagram illustrating an internal configuration of a design management control part 103. With reference to FIG. 3, the design management control part 103 is configured to include a system requirement obtaining part 1031, a requested resource determination part 1032, a spare resource determination part 1033 and a system configuration determination part 1034.

The communication part 101 controls communication function of the design management apparatus 100.

The design management storage part 102 stores information for operating the design management apparatus 100. The design management storage part 102 stores information on requested resources and information on spare resources for each managed system.

The system requirement obtaining part 1031 obtains a system requirement of a managed system. Concretely, the system requirement obtaining part 1031 obtains the system requirement of the managed system from the Web server 400 through a network.

The requested resource determination part 1032 determines a requested resource(s) based on the system requirement. Concretely, the design management control part 103 determines the number of a managed apparatus(es) and a setting(s) of the managed apparatus(es) based on the system requirement of the managed system as information regarding the requested resource(s). The system requirement includes information regarding at least any one of a type of a managed apparatus, an application to be operated by a managed apparatus and a connection method of a managed apparatus (a communication method of a managed apparatus). Furthermore, the system requirement includes information depending on the managed system.

For example, if the managed system is a system configured to include a surveillance camera(s), the system requirement may contain information on a scope of an area to be monitored, information on a target to be monitored, a monitoring condition, and so on. Here, the information on scope of an area to be monitored may be information indicating a concrete area and a section to be monitored. The information on a target to be monitored may be information indicating characteristics such as a size, a shape and behavior and so on of the target to be monitored. Furthermore, the monitoring condition may be information indicating a time and time range of a day for monitoring.

Here, the setting(s) of a managed apparatus(es) is assumed to mean a setting(s) necessary for operating a managed system such as a setting(s) on connection of a managed apparatus(es), a setting(s) on processes which a managed apparatus(es) executes and so on.

The spare resource determination part 1033 performs a fluctuation prediction on the system requirement and determines a spare resource(s). Concretely, the spare resource determination part 1033 determines information regarding the number of a managed apparatus(es) and a setting(s) of the managed apparatus(es) corresponding to at least any one of fluctuation of environment of the managed system and fluctuation of behavior of the managed system, as information regarding the spare resource(s). Here, a fluctuation prediction is to predict the number of a managed apparatus(es) and a setting(s) of the managed apparatus(es) which may become necessary if a system failure, overload and so on occur in the managed system.

More concretely, the spare resource determination part 1033 performs the fluctuation prediction on a system requirement. Then, the spare resource determination part 1033 determines, based on the fluctuation prediction, the number of a managed apparatus(es) and a setting(s) of the managed apparatus(es) which may become necessary if a system failure, overload and so on occur in the managed system, as information regarding the spare resource(s).

The system configuration determination part 1034 determines a system configuration including a requested resource(s) and a spare resource(s). Concretely, the system configuration determination part 1034 determines system configuration information regarding the system configuration including a requested resource(s) and a spare resource(s). Then, the system configuration determination part 1034 transmits the system configuration information to the supply management apparatus 200 and the system operations management apparatus 300 through the communication part 101.

The supply management apparatus 200 is an information processing apparatus (computer) which manages a processing of supplying a managed apparatus(es) to an end user. The supply management apparatus 200 manages information regarding one or more managed apparatuses held by an administrator side of a management system. The supply management apparatus 200 is configured to include a communication part 201, a supply management storage part 202 and a supply management control part 203.

The communication part 201 controls a communication function of the supply management apparatus 200. The communication part 201 receives the system configuration information from the design management apparatus 100.

The supply management storage part 202 stores information for operating the supply management apparatus 200. The supply management apparatus 200 stores information regarding types of one or more managed apparatuses and the number thereof held by the administrator side of the management system.

The supply management apparatus 200 secures, based on the system configuration information, a managed apparatus(es) the number of which corresponds to the requested resource(s) and a managed apparatus(es) the number of which corresponds to the spare resource(s) as a managed apparatus(es) of the managed system.

Concretely, the supply management control part 203 secures, based on the system configuration information, a managed apparatus(es) the number of which corresponds to the requested resource(s) and a managed apparatus(es) the number of which corresponds to the spare resource(s) as a managed apparatus(es) of the managed system.

Furthermore, the supply management apparatus 200 sets up a managed apparatus(es) corresponding to the requested resource(s) in such a manner that a function(s) of a necessary application operates based on the system configuration information. Furthermore, the supply management apparatus 200 sets up a managed apparatus(es) corresponding to the spare resource(s) in such a manner that a function(s) of a necessary application operates based on the system configuration information.

Then, the supply management apparatus 200 executes a processing of delivering the managed apparatus(es) corresponding to the requested resource(s) to a user of the managed apparatus(es). In the following description, a user of a managed apparatus(es) is called an end user of a managed system.

Furthermore, if the supply management apparatus 200 receives an additional delivering request of a managed apparatus(es), the supply management apparatus 200 executes a processing of delivering a managed apparatus(es) corresponding to a spare resource(s) to an end user of a managed system. Here, it is assumed that a managed apparatus(es) corresponding to a spare resource(s) is(are) set in advance in a state where a function(s) of a necessary application operates.

The system operations management apparatus 300 is an information processing apparatus (computer) which manages an application to be operated by a managed apparatus.

The system operations management apparatus 300 is configured to include a communication part 301, a system operations management storage part 302 and a system operations management control part 303.

The communication prat 301 controls a communication function of the system operations management apparatus 300. Concretely, the communication prat 301 receives the system configuration information from the design management apparatus 100. Furthermore, the communication prat 301 receives the information regarding the operation state(s) of the managed apparatus(es) from the managed apparatus(es).

The system operations management storage part 302 stores information for operating the system operations management apparatus 300. Concretely, the system operations management storage part 302 stores one or more application programs. The system operations management storage part 302 stores information regarding a cooperation state(s) between an application(s) and the managed apparatus(es).

The system operations management control part 303 deploys a necessary application based on the received system configuration information. In other words, the system operations management control part 303 sets up a necessary application in a utilizable state based on the received system configuration information.

The managed apparatus(es) operating in the managed system transmits information regarding own operation state(s) to the system operations management apparatus 300. The system operations management control part 303 receives information regarding the operation state(s) of the managed apparatus(es) from the managed apparatus operating in the managed system.

The system operations management control part 303 proposes addition of a managed apparatus(es) to an end user of the managed system according to the operation state(s) of the managed apparatus(es). Concretely, the system operations management apparatus 300 determines whether or not it is necessary to add a managed apparatus(es) to the managed system based on the information regarding the operation state(s). If it is necessary to add a managed apparatus(es) to the managed system, the system operations management apparatus 300 notifies a predetermined destination that it is necessary to add a managed apparatus(es) to the managed system.

Next, an operation of a management system will be described in detail. In the following description, a case where a management system manages a system configured to include a surveillance camera(s) as a managed system will be described by an example. Furthermore, a surveillance camera(s) configuring the managed system is assumed to operate as an IoT device(s) and to be a managed apparatus(es).

Furthermore, in the following description, it is assumed that an end user of a managed system applies for reception of a service provision of the managed system through a Web server 400. Then, if the management system receives service application for a managed system from the Web server 400, it is assumed that the management system configures necessary settings for a surveillance camera(s) configuring the applied managed system and performs a processing of provision to the end user of the managed system.

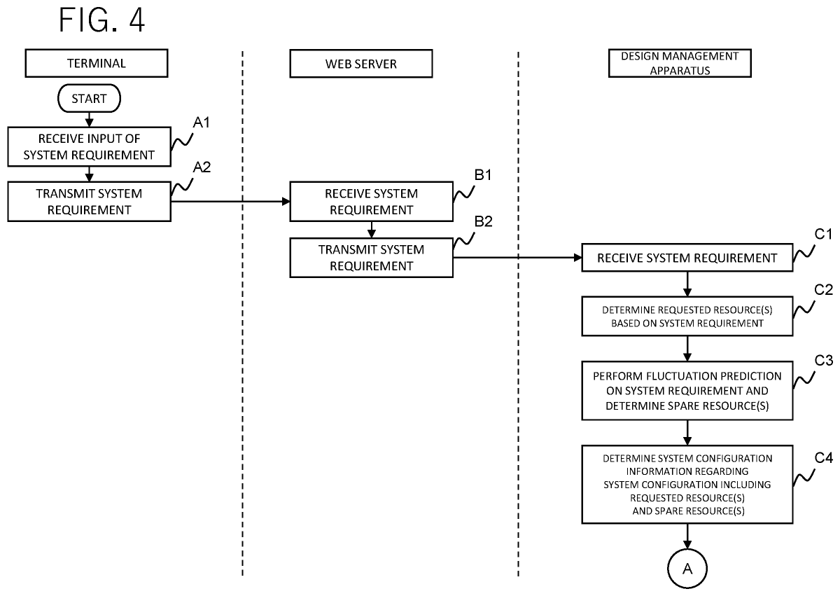

First, an operation of a management system will be described with reference to FIG. 4.

A terminal 50 receives input of a system requirement (step Al). Then, the terminal 500 transmits the system requirement to the Web server 400 (step A2). The system requirement includes information regarding a type of a managed apparatus, an application to be operated by a managed apparatus(es) and a connection method of a managed apparatus(es) and so on.

For example, an end user of a managed system applies for a managed system (a system configured to include a surveillance camera(s)) on an application screen provided by the Web server 400 using the terminal 500. At that time, the end user of the managed system inputs, using the terminal 500, a system requirement regarding an area(s) to be monitored by a surveillance camera(s) on an application screen provided by the Web server 400. The terminal 500 transmits the input system requirement to the Web server 400.

When the Web server 400 receives the system requirement (step B1), the Web server 400 transmits the system requirement to the design management apparatus 100 (step B2).

When the communication part 101 receives the system requirement (step C1), the design management apparatus 100 determines a requested resource(s) based on the system requirement (step C2). Concretely, the requested resource determination part 1032 determines the number of a managed apparatus(es) and a setting(s) of the managed apparatus(es) based on the system requirement as information regarding the requested resources.

For example, if the managed system is a system configured to include a surveillance camera(s), information regarding a requested resource(s) may include information regarding the number of the necessary surveillance cameras (that is, managed apparatuses). Furthermore, if the managed system is a system configured to include a surveillance camera(s), the requested resource may include information necessary to object detection (feature values of the target for detection and so on). Furthermore, if the managed system is a system configured to include a surveillance camera(s), information regarding a requested resource may include information on a shot image(s) (resolution, exposure time, aperture value and so on).

Furthermore, the design management apparatus 100 performs a fluctuation prediction on the system requirement and determines a spare resource(s) (step C3). Concretely, the spare resource determination part 1033 predicts the number of a managed apparatus(es) and a setting(s) of the managed apparatus(es) which may become necessary if a system failure, overload and so on occur in the managed system and determines information regarding the spare resource(s).

For example, if the managed system is a system configured to include a surveillance camera(s), the information regarding the spare resource(s) may be information regarding the number of the surveillance cameras (that is, managed apparatuses) which may become necessary if a system failure, overload and so on occur.

Furthermore, if the managed system is a system configured to include a surveillance camera(s), the information regarding the spare resource(s) may include information regarding feature values of the target for detection in which fluctuation of the feature values of the target for detection is taken into consideration. For example, the information regarding the spare resource(s) may include information regarding feature values of the target for detection in which fluctuation of a size and behavior of the target for detection is taken into consideration.

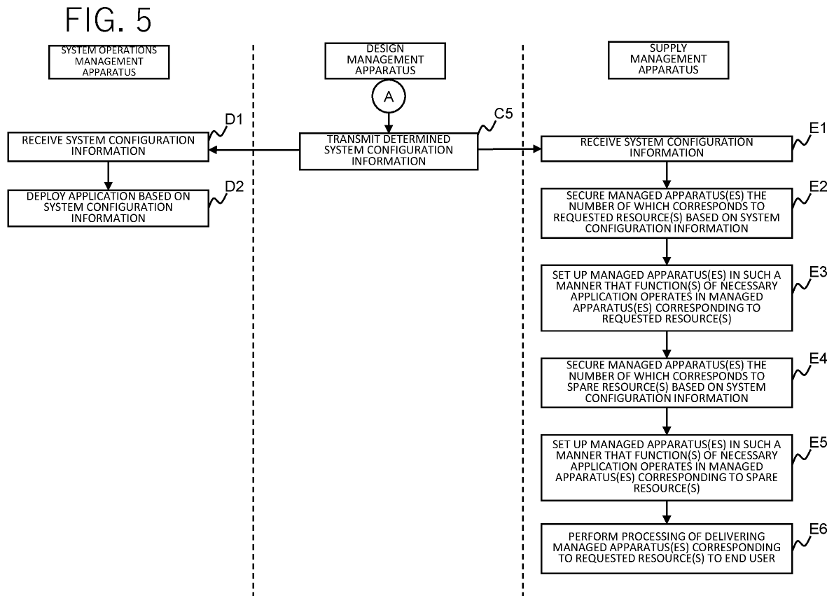

The design management apparatus 100 determines system configuration information regarding system configuration including the requested resource(s) and the spare resource(s) (step C4). Then, the design management apparatus 100 transmits the determined system configuration information to the supply management apparatus 200 and the system operations management apparatus 300 (step C5 as shown in FIG. 5).

Next, with reference to FIG. 5, the operation of the management system will be described subsequently.

The design management apparatus 100 transmits the determined system configuration information to the supply management apparatus 200 and the system operations management apparatus 300 (step C5).

If the system operations management apparatus 300 receives the system configuration information (step D1), the system operations management apparatus 300 causes the application to be utilizable based on the system configuration information (step D2). That is, the system operations management apparatus 300 deploys the application based on the system configuration information.

If the supply management apparatus 200 receives the system configuration information (step E1), the supply management apparatus 200 secures a managed apparatus(es) the number of which corresponds to the requested resource(s) based on the system configuration information (step E2). That is, the supply management apparatus 200 performs a processing to allocate the managed apparatus(es) the number of which corresponds to the requested resource(s) to the managed system based on the system configuration information. Then, the supply management apparatus 200 sets up the managed apparatus(es) in such a manner that a function(s) of a necessary application operates in the managed apparatus(es) corresponding to the requested resource(s) (step E3).

Furthermore, the supply management apparatus 200 secures a managed apparatus(es) the number of which corresponds to the spare resource(s) based on the system configuration information (step E4). That is, the supply management apparatus 200 performs, based on the system configuration information, a processing to allocate the managed apparatus(es) the number of which corresponds to the requested resource(s) to the managed system based on the system configuration information. Then, the supply management apparatus 200 sets up the managed apparatus(es) in such a manner that a function(s) of a necessary application operates in the managed apparatus(es) corresponding to the spare resource(s) (step E5).

Then, the supply management apparatus 200 performs a processing of delivering a managed apparatus(es) corresponding to the requested resource(s) to an end user of the managed system (step E6).

For example, if the managed system is a system configured to include a surveillance camera(s), the end user of the managed system arranges the surveillance camera(s) in the area(s) to be monitored when the surveillance camera(s) that is the managed apparatus(es) is(are) received.

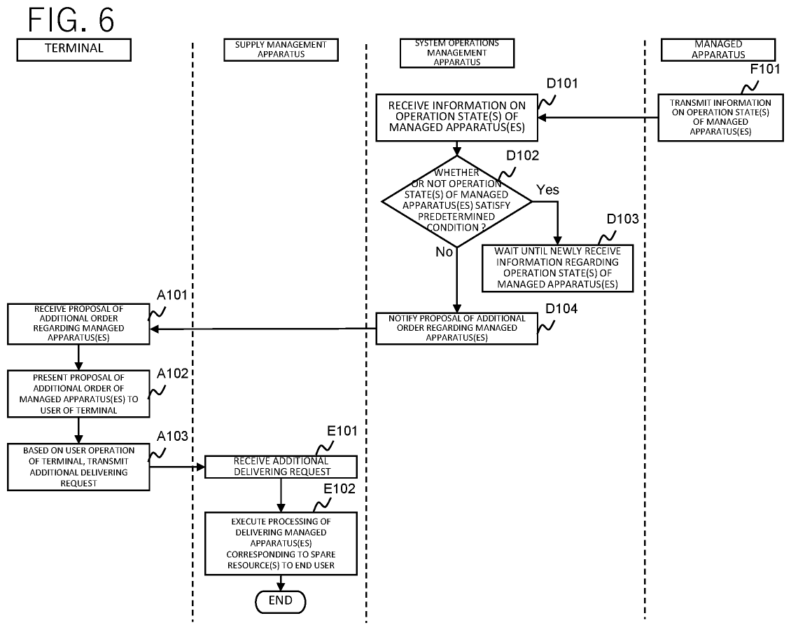

Next, with reference to FIG. 6, a case where the end user orders a managed apparatus(es) corresponding to the spare resource(s) will be described. Note, in the following description, it is assumed that a managed apparatus(es) corresponding to the requested resource(s) is in operation in the managed system.

The managed apparatus transmits information on an operation state(s) of the managed apparatus(es) to the system operations management apparatus 300 (step F101).

For example, the managed apparatus(es) may transmit the information on an operation state(s) of the managed apparatus(es) to the system operations management apparatus 300 at a predetermined time interval. Furthermore, for example, when the managed apparatus(es) performed a predetermined processing, the managed apparatus(es) may transmit the information on an operation state(s) of the managed apparatus(es) to the system operations management apparatus 300.

The information on an operation state(s) of the managed apparatus(es) may include information on at least any one of input data to the managed apparatus(es), output data from the managed apparatus(es), a processing result(s) of the managed apparatus(es) and a communication state(s). For example, if the managed system is a system configured to include a surveillance camera(s), the information on an operation state(s) of the managed apparatus(es) may include information on a detected target to be monitored, information on image quality of a shot image, information on a communication state(s) and so on.

If the system operations management apparatus 300 receives the information on an operation state(s) of the managed apparatus(es) (step D101), the system operations management apparatus 300 determines whether or not the operation state(s) of the managed apparatus(es) satisfies a predetermined condition (step D102).

For example, if a processing load(s) of the managed apparatus(es) is less than or equal to a predetermined threshold value, the system operations management apparatus 300 may determine that the operation state(s) of the managed apparatus(es) satisfies the predetermined condition. On the other hand, the processing load(s) of the managed apparatus(es) exceeds the predetermined threshold value, the system operations management apparatus 300 may determine that the operation state(s) of the managed apparatus(es) does not satisfy the predetermined condition.

Furthermore, for example, if the managed apparatus(es) outputs predetermined data within a predetermined time, the system operations management apparatus 300 may determine that the operation state(s) of the managed apparatus(es) satisfies the predetermined condition. On the other hand, if the managed apparatus(es) does not output the predetermined data within the predetermined time, the system operations management apparatus 300 may determine that the operation state(s) of the managed apparatus(es) does not satisfy the predetermined condition.

Furthermore, for example, if a response time(s) of the managed apparatus(es) is less than or equal to a predetermined threshold value, the system operations management apparatus 300 may determine that the operation state(s) of the managed apparatus(es) satisfies the predetermined condition. On the other hand, the response time(s) of the managed apparatus(es) exceeds the predetermined threshold value, the system operations management apparatus 300 may determine that the operation state(s) of the managed apparatus(es) does not satisfy the predetermined condition. Furthermore, for example, if there is no response from the managed apparatus(es), the system operations management apparatus 300 may determine that the operation state(s) of the managed apparatus(es) does not satisfy the predetermined condition.

If the operation state(s) of the managed apparatus(es) satisfies the predetermined condition (Yes branch of step D102), the system operations management apparatus 300 waits until the system operations management apparatus 300 newly receives information regarding an operation state(s) of the managed apparatus(es) (step D103).

On the other hand, if the operation state(s) of the managed apparatus(es) does not satisfy the predetermined condition (No branch of step D102), the system operations management apparatus 300 notifies the terminal 500 of a proposal of an additional order regarding the managed apparatus(es) (step D104). If the terminal 500 receives the proposal of the additional order regarding the managed apparatus(es) (step A101), the terminal 500 presents the proposal of the additional order of the managed apparatus(es) to a user of the terminal 500 (step A102). For example, the user of the terminal 500 may be the end user of the managed apparatus(es).

Then, the terminal 500, based on a user operation of the terminal 500, transmits an additional delivering request to the supply management apparatus 200 (step A103). For example, the end user of the managed system may place an additional order of a managed apparatus(es) on an additional order application screen provided by the Web serve using the terminal 500. In that case, the terminal 500 transmits the additional delivering request to the supply management apparatus 200 through the Web server 400.

If the supply management apparatus 200 receives the additional delivering request (step E101), the supply management apparatus 200 executes a processing of delivering the managed apparatus(es) corresponding to the spare resource(s) to the end user (step E102).

As described above, in the management system according to the present example embodiment, the design management apparatus 100 determines a configuration of a managed system by predicting in advance the number of a managed apparatus(es) and a setting(s) of a managed apparatus(es) which may become necessary if a system failure, overload and so on occur. Then, in the management system according to the present example embodiment, the system operations management apparatus 300 determines whether or not the managed apparatus(es) corresponding to the spare resource(s) is necessary based on the operation state(s) of the managed apparatus(es). Then, in the management system according to the present example embodiment, if it is necessary to add a managed apparatus(es) corresponding to the spare resource(s), the system operations management apparatus 300 proposes an order of the spare resource(s) to the end user. Then, if the supply management apparatus 200 receives the order of the spare resource(s), the supply management apparatus 200 executes a processing of delivering the managed apparatus(es) (IoT device(s)) which have been cooperated with an application corresponding to the requested resource(s) to the end user.

Therefore, by utilizing the management system according to the present example embodiment, it is possible to secure and set up a resource(s) by assuming in advance that a system failure, overload and so on occur. Therefore, the management system according to the present example embodiment contributes to promptly implement a design change in a system and operate the system even when the design change of the system becomes necessary. As a result, the management system according to the present example embodiment contributes to cause the system to be managed to be continuously operable.

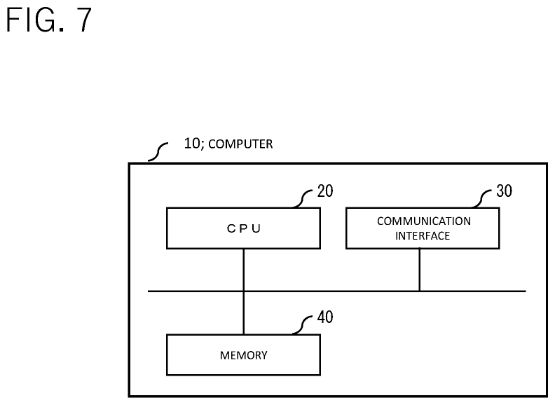

FIG. 7 shows a block diagram illustrating an example of a hardware configuration of a computer 10 which realizes the design management apparatus 100.

For example, the computer 10 includes a CPU (Central Processing Unit) 20, a communication interface 30, a memory 40 and so on which are connected to each other by an internal bus. The communication interface 30 is a NIC (Network Interface Card) and so on. The memory is a magnetic disk apparatus, an optical disk apparatus, a semiconductor memory and so on.

A function(s) of the design management apparatus 100 is realized by the CPU 20 executing a program stored in the memory 40. All or part of functions of the design management apparatus 100 may be realized by hardware (implemented in hardware) such as an FPGA (Field Programmable Gate Array), ASIC (Application Specific Integrated Circuit) and so on. Furthermore, the above program can be updated by downloading through a network or using a storage media which stores the program thereon. That is, the function(s) of the design management apparatus 100 may be realized by executing a software in any hardware.

Note, because basic hardware configurations of the supply management apparatus 200 and the system operations management apparatus 300 may be the same as the hardware configuration of the computer 10 as shown in FIG. 7, the detailed description will be omitted.

Although whole or part of the example embodiments described above can be described as, but not limited to, the following notes.

[Note 1]

Refer to the design management apparatus from the first aspect.

[Note 2]

The design management apparatus according to note 1, wherein the requested resource determination part determines information regarding the number of a managed apparatus(es) and a setting(s) of the managed apparatus(es) satisfying a system requirement of a managed system as information regarding the requested resource(s); and the spare resource determination part determines information regarding the number of a managed apparatus(es) and a setting(s) of the managed apparatus(es) corresponding to at least any one of variation of an environment of the managed system and variation of an operation of the managed system as information regarding the spare resource(s).

[Note 3]

The design management apparatus according to note 1 or 2, wherein the managed apparatus includes communication facilities; and the system requirement includes information regarding at least any one of a type of the managed apparatus, an application to be operated by the managed apparatus and a communication method of the managed apparatus.

[Note 4]

Refer to the management system from the second aspect.

[Note 5]

The management system according to note 4, wherein the supply management apparatus secures, based on the system configuration information, a managed apparatus(es) the number of which corresponds to the requested resource(s) and a managed apparatus(es) the number of which corresponds to the spare resource(s) as a managed apparatus(es) of the managed system.

[Note 6]

The management system according to note 4 or 5, further comprising: a system operations management apparatus which manages an application to be operated by a managed apparatus(es); and wherein the supply management apparatus sets up a managed apparatus(es) corresponding to the requested resource(s) and a managed apparatus(es) corresponding to the spare resource(s) to a state where an application corresponding to the system configuration information can be executed.

[Note 7]

The management system according to note 6, wherein a managed apparatus(es) includes communication facilities; a managed apparatus(es) which operates in the managed system transmits information regarding an own operation state(s) to the system operations management apparatus; and the system operations management apparatus determines whether or not it is necessary to add a managed apparatus(es) to the managed system based on the information regarding the operation state(s).

[Note 8]

The management system according to note 7, wherein the system operations management apparatus notifies a predetermined destination that it is necessary to add a managed apparatus(es) to the managed system.

[Note 9]

The management system according to any one of notes 4 to 8, wherein the supply management apparatus performs a processing of delivering a managed apparatus(es) corresponding to the spare resource(s) set up in a state where an application corresponding to the system configuration information can be executed, to the end user of the managed system.

[Note 10]

The management system according to any one of notes 4 to 9, wherein the information on an operation state(s) includes information on at least any one of input data to the managed apparatus(es), output data from the managed apparatus(es), a processing result(s) of the managed apparatus(es) and a communication state(s) of the managed apparatus(es).

[Note 11]

Refer to the control method of the design management apparatus from the third aspect.

[Note 12]

Refer to the control method of the supply management apparatus from the fourth aspect.

[Note 13]

Refer to the control method of the system operations management apparatus from the fifth aspect.

[Note 14]

Refer to the program from the sixth aspect. [Note 15]

Refer to the program from the seventh aspect.

[Note 16]

Refer to the program from the eighth aspect.

Please note that the disclosure of the above Patent Literatures is incorporated herein by reference thereto and is considered to be described therein, and can be used as a basis and a part of the present invention if needed. Variations and adjustments of the example embodiments and examples are possible within the scope of the overall disclosure (including the claims) of the present invention and based on the basic technical concept of the present invention. Various combinations and selections (including partial deletion) of various disclosed elements (including the elements in each of the claims, example embodiments, examples, drawings, etc.) are possible within the scope of the entire disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned. In the present invention, it is obvious that a computer is used in a case where an algorithm, a software, and a flowchart or automated process steps are indicated and also obvious that a computer is equipped with a processor and a memory or a storage device. If those are not definitely described, the present invention is construed that those elements are of course described.

### SIGNS LIST

10 computer
20 CPU
30 communication interface
40 memory
100, 1000 design management apparatus
101, 201, 301 communication part
102 design management storage part
103 design management control part
200 supply management apparatus
202 supply management storage part
203 supply management control part
300 system operations management apparatus
302 system operations management storage part
303 system operations management control part
400 Web server
500 terminal
1001, 1031 system requirement obtaining part
1002, 1032 requested resource determination part
1003, 1033 spare resource determination part
1004, 1034 system configuration determination part

What is claimed is:

1. A design management apparatus, comprising:
at least a processor; and
a memory in circuit communication with the processor,
wherein the processor is configured to execute program instructions stored in the memory to implement:
a system requirement obtaining part which obtains a system requirement of a managed system configured to include a managed apparatus(es);
a requested resource determination part which determines a requested resource(s) based on the system requirement;
a spare resource determination part which determines a spare resource(s) by performing a fluctuation prediction on the system requirement; and
a system configuration determination part which determines system configuration information regarding a system configuration including the requested resource(s) and the spare resource(s).

2. The design management apparatus according to claim 1, wherein
the requested resource determination part determines information regarding the number of a managed apparatus(es) and a setting(s) of the managed apparatus(es) satisfying a system requirement of a managed system as information regarding the requested resource(s); and
the spare resource determination part determines information regarding the number of a managed apparatus(es) and a setting(s) of the managed apparatus(es) corresponding to at least any one of variation of an environment of the managed system and variation of an operation of the managed system as information regarding the spare resource(s).

3. The design management apparatus according to claim 1 wherein
the managed apparatus includes communication facilities; and
the system requirement includes information regarding at least any one of a type of the managed apparatus, an application to be operated by the managed apparatus and a communication method of the managed apparatus.

4. A management system, wherein the management system is configured to comprise a design management apparatus and a supply management apparatus;
wherein the design management apparatus comprises:
at least a processor; and
a memory in circuit communication with the processor,
wherein the processor is configured to execute program instructions stored in the memory to implement:
a system requirement obtaining part which obtains a system requirement of a managed system configured to include a managed apparatus(es);
a requested resource determination part which determines a requested resource(s) based on the system requirement;
a spare resource determination part which determines a spare resource(s) by performing a fluctuation prediction on the system requirement; and
a system configuration determination part which determines system configuration information regarding a system configuration including the requested resource(s) and the spare resource(s), and transmits the system configuration information to the supply management apparatus; and
wherein the supply management apparatus comprises:
at least a processor; and
a memory in circuit communication with the processor,
wherein the processor is configured to execute program instructions stored in the memory to implement:
the supply management apparatus secures an apparatus(es) corresponding to the requested resource(s) and the spare resource(s) as a managed apparatus(es) if the system configuration information is received, and performs a processing of delivering a managed apparatus(es) corresponding to the requested resource(s) to an end user of the managed system.

5. The management system according to claim 4, wherein the supply management apparatus secures, based on the system configuration information, a managed apparatus(es) the number of which corresponds to the requested resource(s) and a managed apparatus(es) the number of which corresponds to the spare resource(s) as a managed apparatus(es) of the managed system.

6. The management system according to claim 4, wherein the processor is configured to execute the program instructions to implement:
a system operations management apparatus which manages an application to be operated by a managed apparatus(es); and
wherein the supply management apparatus sets up a managed apparatus(es) corresponding to the requested resource(s) and a managed apparatus(es) corresponding to the spare resource(s) to a state where an application corresponding to the system configuration information can be executed.

7. The management system according to claim 6, wherein
a managed apparatus(es) includes communication facilities;
a managed apparatus(es) which operates in the managed system transmits information regarding an own operation state(s) to the system operations management apparatus; and
the system operations management apparatus determines whether or not it is necessary to add a managed apparatus(es) to the managed system based on the information regarding the operation state(s).

8. The management system according to claim 4, wherein
the supply management apparatus performs a processing of delivering a managed apparatus(es) corresponding to the spare resource(s) set in a state where an application corresponding to the system configuration information can be executed, to the end user of the managed system.

9. (canceled)

10. A computer-readable non-transient recording medium recording a program, the program that causes a computer which controls a design management apparatus to execute processings, comprising:
obtaining a system requirement of a managed system configured to include a managed apparatus(es);
determining a requested resource(s) based on the system requirement;
determining a spare resource(s) by performing a fluctuation prediction on the system requirement; and
determining system configuration information regarding a system configuration including the requested resource(s) and the spare resource(s).

11. The management system according to claim 4, wherein
the requested resource determination part determines information regarding the number of a managed apparatus(es) and a setting(s) of the managed apparatus(es) satisfying a system requirement of a managed system as information regarding the requested resource(s); and
the spare resource determination part determines information regarding the number of a managed apparatus(es) and a setting(s) of the managed apparatus(es) corresponding to at least any one of variation of an environment of the managed system and variation of an operation of the managed system as information regarding the spare resource(s).

12. The management system according to claim 4, wherein
the managed apparatus includes communication facilities; and
the system requirement includes information regarding at least any one of a type of the managed apparatus, an application to be operated by the managed apparatus and a communication method of the managed apparatus.

13. The computer-readable non-transient recording medium according to claim 10, wherein
the determining requested resource(s) determines information regarding the number of a managed apparatus(es) and a setting(s) of the managed apparatus(es) satisfying a system requirement of a managed system as information regarding the requested resource(s); and
the determining spare resource(s) determines information regarding the number of a managed apparatus(es) and a setting(s) of the managed apparatus(es) corresponding to at least any one of variation of an environment of the managed system and variation of an operation of the managed system as information regarding the spare resource(s).

14. The computer-readable non-transient recording medium according to claim 10, wherein
the managed apparatus includes communication facilities; and
the system requirement includes information regarding at least any one of a type of the managed apparatus, an application to be operated by the managed apparatus and a communication method of the managed apparatus.
